(19) United States
(12) Patent Application Publication
(10) Pub. No.: US 2009/0109104 A1
(43) Pub. Date: Apr. 30, 2009

(54) Balanced-Unbalanced Antennas

(75) Inventors: Jonathan Ide, Queensland (AU); Simon Philip Kingsley, Cambridge (GB); Steven Gregory O'keefe, Queensland (AU); Seppo Saario, Brisbane (AU); Devis Iellici, Cambridge (GB); Robert Walter Schlub, San Jose, CA (US); Brian Collins, Kent (GB)

Correspondence Address: Pearl Cohen Zedek Latzer, LLP, 1500 Broadway, 12th Floor, New York, NY, 10036, US

(73) Assignee: ANTENOVA LIMITED, Stow-cum-Quy (GB)

(21) Appl. No.: 11/883,368

(22) PCT Filed: Jan. 31, 2006
(86) PCT No.: PCT/GB06/00312

§ 371 Date: Jul. 22, 2008

(30) Foreign Application Priority Data
Feb. 1, 2005 (GB) 0501938.5

(51) Int. Cl. H01Q 1/50; H01Q 21/29; H01Q 9/16

(52) U.S. Cl. 343/730; 343/859

(57) ABSTRACT

There is disclosed an antenna device comprising a pair of physically and electrically symmetrical radiating elements configured for cooperative operation as a balanced antenna, and a third radiating element configured for operation as an unbalanced antenna The balanced antenna may be configured for operation in a first frequency band, and the unbalanced antenna may be configured for operation in a second frequency band Embodiments of the disclosed antenna device provide multiband operation close to a conductive groundplane and are strongly resistant to detuning.

The present invention relates to antennas, in particular but not exclusively for portable devices. It applies to all types of antennas and is not restricted to PIFAs (planar inverted F-antennas), monopoles, dielectric antennas and the like. It applies to various applications, but is particularly, though not exclusively, concerned with mobile phone handsets, personal digital assistants (PDAs) and laptop computers.

### BACKGROUND

The design of internal antennas for small modern communication devices is well known to be a difficult problem.

Firstly, there are many different types of platforms, especially for handsets where clamshell designs, bar phones, flip phones, slider and swing phone designs are all common. For example, the connections between the two parts of segmented phones can have a large impact on the antenna performance.

Secondly, modern communication devices are getting smaller and at the same time the antenna is being asked to cover more bands.

Thirdly, other radios and other antennas may be present for applications such GPS, Bluetooth®, digital media broadcasting, etc., and this can cause coupling and co-sited transmitter problems.

Finally, there is an increasing call for multiple radio antennas in a single unit for diversity or MIMO (multiple input, multiple output) applications.

While all these factors lead to an increase in the complexity of the antenna, commercial pressures require the antenna to be ever cheaper and to occupy less volume in the handset. With the bill of materials already pared to a minimum, larger scale integration of components is seen as the way forward to further cost reductions. One way to address all these issues is to consider the antenna and RF (radio frequency) front-end together as a single unit thus creating a radio-antenna unit. Such a radio-antenna unit could exploit different radio architectures such as balanced RF and antenna structures, impedances other than 50 ohms, etc.

The present applicant has thus become interested not just in antennas but the whole of the process of converting electrical signals into radio waves and vice versa. The ultimate objective is to design a single module that will incorporate the antenna and all the radio components for cellular radio or WLAN applications. In order to drive the antenna from conventional cellular or WLAN radio transceivers, it may be necessary to incorporate discrete ICs (integrated circuits) from third party manufacturers. An example of such a discrete component is a chip balun that is needed when a balanced dipole-like antenna is driven from a single ended unbalanced source such as a power amplifier (PA).

It is envisaged by the present applicant that some of the functionality of these ICs will ultimately be built directly into the antenna. Duplexers and filters, for example, could be fabricated as part of the lower layers of a multi layer antenna structure, rattier than being separate components integrated into the module. An alternative approach would be to adapt PAs and other radio components such that the necessary balanced and filtered outputs are produced. This ultimate radio module, containing a special purpose antenna and specially adapted radio components, would remove the need for mobile phone handset manufacturers to be radio experts as they would effectively have a device with a digital input/output and everything else would be taken care of by the module. These inventions concerning a radio-antenna module are the subject of a separate patent application due to the present applicant (UK patent application No 0501170.5).

Conventional antennas for mobile wireless communications, such as external stubby antennas and internal PIFAs, are of the unbalanced type and induce large currents that flow in the conductive surface of the PCB. This cannot be avoided because the PCB is effectively half the antenna. When a mobile device such as a telephone is held in the human hand there is some absorption of the current flowing, causing a loss of efficiency, and some detuning of the antenna.

In contrast, balanced radiating elements do not need a groundplane or conductive surface and offer the advantage of reduced detuning and greater efficiency when the mobile device is in normal use. However, balanced radiating elements must typically be positioned at least one quarter of a wavelength from a conductive surface such as the PCB of a mobile phone or the like. At 824 MHz (the bottom of the GSM band) this is equivalent to a distance of about 90 mm and is impractical in a small mobile phone or other device. A problem to be solved is the creation of a balanced antenna that win work electrically close to a conductive surface.

Most existing mobile phone handset, PDA and laptop computer antennas are unbalanced designs such as PIFAs and monopoles. These are small and make effective use of the PCB (printed circuit board) or PWB (printed wiring board) as part of the antenna, but they need extensive customisation for every product because every PCB/PWB is a different shape and/or size. Antenna customisation is an expensive process that forms a significant part of the cost of a device and precludes the use of integrated radio-antenna modules, as the cost of customizing these would be prohibitive.

Progress towards integrated antennas could be made by the introduction of balanced antennas that do not make use of the PCB and so require less customisation. Unfortunately, balanced antennas are often twice the size of their unbalanced counterparts and also have less bandwidth because they are not using a wide PCB as part of the radiating structure. A further complication is that many types of balanced antenna (dipoles, spiral pairs, etc.) are adversely affected by self-induced image currents when they are placed electrically close to a groundplane. Modern handsets, PDAs and laptop computers generally have a full groundplane and the antenna sits less than 1/50 of a free-space wavelength above it.

To circumvent this problem, the present applicant has developed a number of new types of balanced antenna that are small enough for use in a handset, etc. and will work over the top of a fully populated PCB or PWB groundplane.

Prior art concerning such antennas is disclosed, for example, by JP2004173317 and EP1094542 (MATUSHITA). These disclosures address the problem of making a balanced antenna work electrically close to a conductive surface through the use of a complementary pair, of PIFAs (or similar shaped antennas having groundplanes) and with a substantially 180 degree phase shift between feeds. The Matsushita references disclose the following features:
1. The concept of a complementary pair of back-to-back PIFAs having their shorted ends placed together.
2. Slotted and meandered version of above.
3. Slotted PIFA pairs with switching circuits to change frequency.
4. The use of a dielectric substrate to support the PIFAs. An Er of 3.6 is proposed
5. A complementary pair of PIFAs having their shorted sides away from each other on the outside and their radiating ends facing each other.

The Matsushita references do not disclose any other type of antenna than various types of PIFA, nor do they disclose symmetry greater than single-axis symmetry, balanced/unbalanced operation or simultaneous dual band operation.

For all the high bands (above about 1.5 GHz), mobile communications devices generally need to make use of balanced (dipole-like) antennas. The reasoning behind this is:
a Existing handset antennas are all unbalanced (monopole-like) designs and need extensive customisation for every product because every PCB is a different shape and size.
Therefore modules built using conventional technology would also need customisation for every product.
But customisation of a radio antenna module for every product would be prohibitively expensive, and the OEM or ODM companies would still need to employ antenna engineers.

Balanced antenna designs have thus been developed for, these frequency bands as these have an inherent independence of the groundplane making it easier to use the same module in many different types of handsets, laptops, etc. There is a difficulty, however. In the low band (800/900 MHz) the antenna must be unbalanced as the wavelength is so long that the whole PCB is needed as the primary radiator. The antenna on its own would be inside the Chu-Harrington limit [L., J. Chu, “Physical limitations of Omni-Directional Antennas,” Journal of Applied Physics, Vol. 19, pp. 1163-1175, 1948], [R. C. Hansen, “Fundamental Limitations in Antennas,” Proceedings of the IEEE, Vol. 69, No. 2, pp. 170-182, 1981]. An antenna inside the Chu-Harrington limit would be an inefficient radiator, lack sufficient bandwidth or both. No such restriction applies in the high band (1800/1900 MHz) and here a balanced antenna is a positive advantage for the reasons given.

### BRIEF SUMMARY OF THE DISCLOSURE

According to a first aspect of the present invention, there is provided an antenna device comprising a pair of physically and electrically symmetrical radiating elements configured for cooperative operation as a balanced antenna, and a third radiating element configured for operation as an unbalanced antenna.

The balanced antenna radiating elements may be provided as part of a housing or support structure that encloses the unbalanced antenna radiating element.

Alternatively, the unbalanced antenna radiating element may be provided as part of a housing or support structure that encloses the balanced antenna radiating elements.

The housing or support structure is preferably made of a dielectric material, for example a plastics material, and is advantageously designed to be clipped or otherwise attached to a PCB or PWB substrate.

The antenna device may be configured for operation in both first and second frequency bands, which may be non-overlapping frequency bands, wherein the device acts as an unbalanced antenna in the first frequency band and as a balanced antenna in the second frequency band.

It is generally the case that the first frequency band, in which the device acts as an unbalanced antenna, is of lower frequency than the second frequency band in which the device acts as a balanced antenna, although in some embodiments the first frequency band may be higher than the second frequency band.

In some embodiments, the balanced antenna radiating elements are provided with a first frequency band shorting connection such that they together form the third, unbalanced radiating element in the first frequency band, while still acting separately as a balanced pair in the second frequency band.

Advantageously, the antenna device further comprises a diplexer to separate an unbalanced feed signal into one or more signals in the first frequency band and one or more signals in the second frequency band, wherein a balun is provided to convert the second band signals into a balanced feed signal for feeding to the balanced antenna radiating elements, and wherein the first band signals are fed as an unbalanced signal to the unbalanced antenna radiating element.

Alternatively, the antenna device further comprises a diplexer to separate a balanced feed signal into one or more signals in the first frequency band and one or more signals in the second frequency band, wherein a balun is provided to convert the first band signals into an unbalanced feed signal for feeding to the unbalanced antenna radiating element, and wherein the second band signals are fed as a balanced signal to the balanced antenna radiating elements.

The balanced antenna radiating elements may be symmetrical about a plane orthogonal to a principal direction of extension of the elements. In some particular embodiments, the elements are additionally symmetrical about a plane containing the principal direction of extension of the elements (i.e. the elements have two-fold symmetry).

The balanced antenna radiating elements may together comprise a dipole, a symmetrical pair of inverted-L antennas, a symmetrical pair of planar inverted-L antennas (PILAs), a symmetrical pair of inverted F antennas or a symmetrical pair of planar inverted-F antennas (PIFAs).

The unbalanced antenna radiating element may be configured as a monopole, an inverted-L antenna or PILA. It will be appreciated that the unbalanced antenna radiating element requires a groundplane, for example a conductive groundplane of a PCB or PWB, when operating.

In some embodiments, there is provided a push-pull balanced feed between the balanced antenna radiating elements, and means for adjusting a phase shift between the feeds to each of the balanced antenna radiating elements so as to change a direction of signal radiation or reception.

The balanced antenna radiating elements may be provided with terminals for direct or indirect connection to corresponding terminals of a balanced radio transmitter or receiver.

A pair of the antenna devices of this aspect of the invention may be mounted orthogonally to each other. This has been found to create a degree of both beam and polarisation diversity. Antenna diversity is a useful concept when trying to improve the quality of a communications link. Polarisation diversity is difficult to achieve with unbalanced antennas because surface currents induced in the groundplane tend to run in the same direction.

Provision of a physically and electrically symmetrical pair of balanced antenna radiating elements means that any currents induced in a conductive groundplane that may be located beneath the elements during operation of the device will tend substantially to cancel each other out so as to leave a negligible residual current in the groundplane during operation.

Advantageously, two antenna devices of embodiments of the present disclosure may be disposed orthogonally to each other on the groundplane.

According to a second aspect of the present invention, there is provided an antenna device comprising:
i) first and second antenna elements;
ii) a diplexer to separate an unbalanced feed signal into an unbalanced first frequency band feed signal and an unbalanced second frequency band feed signal;
iii) a balun to convert the unbalanced second frequency band feed signal into a balanced second frequency band feed signal for feeding the first and second antenna elements together as a balanced pair; and
iv) a first frequency band shorting element connecting the first and second antenna elements such that the first and second antenna elements can be driven together as an unbalanced antenna by the unbalanced first frequency band feed signal.

According to a third aspect of the present invention, there is provided an antenna device comprising:
i) first and second antenna elements;
ii) a diplexer to separate a balanced feed signal into:
   a) a balanced second frequency band feed signal for feeding the first and second antenna elements together as a balanced pair, and
   b) a balanced first frequency band feed signal;
iii) a balun to convert the balanced first frequency band feed signal into an unbalanced first frequency band feed signal, and
iv) a first frequency band shorting element connecting the first and second antenna elements such that the first and second antenna elements can be driven together, as an unbalanced antenna by the unbalanced first frequency band feed signal.

The first frequency band shorting element may, for example, comprise an electronic or electromechanical switch, a low- or high-pass filter or a resonant ‘tank’ circuit. Generally speaking, the shorting element comprises any device, switch or connection that makes the first and second antenna elements appear as a single, unbalanced antenna to signals in the first frequency band, and as a pair of separate, balanced antennas to signals in the second frequency band.

According to a fourth aspect of the present invention, there is provided an antenna device comprising first and second antenna elements, a diplexer to separate an unbalanced feed signal into an unbalanced first frequency band feed signal and an unbalanced second frequency band feed signal, a balun to convert the unbalanced second frequency band feed signal into a balanced second frequency band feed signal for feeding the first and second antenna elements together as a balanced pair, and a third unbalanced antenna element that is fed by the unbalanced first frequency band feed signal.

The third unbalanced antenna element may be located close or adjacent to, for example underneath, the first and second antenna elements, or may be located elsewhere or remotely within a portable device that utilises the antenna device.

In most embodiments, the device is designed for operation in which the first frequency band is a “low band” that is lower in frequency than the second frequency band which is a “high band”. However, in some applications the first frequency band may be higher in frequency than the second frequency band.

It will be understood that the terms “high band” and ‘low band’ are defined relative to each other. In other words, the “high band” signal is in a higher band than the “low band” signal and vice versa.

According to a fifth aspect of the present invention, there is provided an antenna device comprising a first generally planar conductive element having first and second opposed ends, and second and third generally planar conductive elements depending respectively from said first and second opposed ends and folded back towards each other over, the first element and spaced therefrom, wherein the first element is provided with a feed for an unbalanced first frequency band signal and wherein the second and third elements are respectively provided with a feed for a balanced second frequency band signal.

The first element with its first frequency band feed operates in the first frequency band as an unbalanced antenna, e.g. a PIFA. The second and third elements with their second frequency band feeds operate together in the second frequency band as a balanced dipole antenna, e.g. an inverted T-matched folded dipole or an inverted folded dipole.

The second frequency band feeds may couple capacitively with the second and third elements, and may be coplanar therewith or non-coplanar (for example, located between the first element and each of the second and third elements).

Alternatively, the second frequency band feeds may be galvanically coupled to the second and third elements.

The first frequency band feed may be galvanically coupled to the first element, and a ground connection may also be provided so that the first element may operate as a PIFA.

A slot may be provided in the first element in the region of the first frequency band feed.

The first, second and third antenna elements and the high band feeds may all be configured from a single sheet of flexible conductive material, or flexible conductive material coated onto a flexible dielectric substrate, for, example flex circuit material, cut and folded in an appropriate manner.

Embodiments of the present invention are advantageously configured as modular units comprising a casing or housing in which the various antenna components are disposed, the casing or housing being adapted for fitting to a PCB or PWB of a portable communications device, the PCB or PWB generally including a conductive groundplane.

The casing or housing is preferably made of a dielectric material, for example a plastics material, and may be provided with protruding feet or the like adapted to clip into complementary apertures in the PCB or PWB.

In all of the embodiments outlined above, a second pair of balanced antenna elements may be provided in addition to the main pair of balanced antenna elements so as to improve bandwidth, especially in the second frequency band. The second pair, of balanced antenna elements will generally be fed with the same or similar frequency band signal as the main pair of balanced antenna elements in a similar fashion.

The benefits of such a radio module with balanced-unbalanced antenna architecture are:
1. ‘One module fits all’—the device is independent of ground plane (except for the low band, if present) and so the module can be used on all kinds of differently-sized devices.
2. When a low band unbalanced antenna is not integral with the device, it will work anywhere on the product and does not have to be at an edge of the PCB/PWB. When a low band unbalanced antenna is integral with the device, it is believed that the device does need to be located at an edge of the PCB/PWB.
3. It is strongly resistant to hand de tuning. With unbalanced antennas there are currents flowing on the PCB/PWB, and when a user's hand grasps the device (e.g. a mobile telephone handset) containing the antenna module, these currents are disturbed and the antenna detunes. This effect is avoided with balanced antennas
4. It is a published result that balanced antennas should create low SAR (specific absorption rate) conditions. The present applicants have found that balanced antennas can be designed to radiate away from the PCB/PWB and therefore away from the human head when the handset is used in the talk position. This should create lower SAR values.
5. The total RF front end and antenna efficiency may be increased through:
   Reduced chassis currents.
   Reduced front-end losses.
   Reduced detuning effects in the ‘talk position’.
6. When an antenna is not only balanced but also referred to earth (sometimes known as push-pull operation), there is scope for suppression of odd harmonics thus making it easier to meet linearity requirements for handsets.
7. Less customisation by OEMs and ODMs manufacturing handsets means they can get products to market faster.

Throughout the description and claims of this specification, the words “comprise” and “contain” and variations of the words, for example “comprising” and “comprises”, means “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers and/or characteristics described in conjunction with a particular aspect, embodiment or example of the invention are to be understood to be applicable to any other aspect, embodiment or example described herein unless incompatible therewith.

### BRIEF DESCRIPTION OF THE DRAWINGS

For a better understanding of the present invention and to show how it may be carried into effect, reference shall now be made by way of example to the accompanying drawings, in which:

FIG. 1 shows an antenna module comprising a pair of self-complementary antennas;

FIG. 2 shows an antenna module comprising a pair of self-complementary antennas with two-fold symmetry;

FIG. 3 shows a block diagram of a balanced-unbalanced antenna using a single antenna structure;

FIG. 4 shows a block diagram of a balanced-unbalanced antenna using a balanced high-band antenna and a separate unbalanced low-band antenna;

FIG. 5 shows a prior, art folded dipole having the advantage of a an input impedance four times higher than that of a simple dipole;

FIG. 6 shows a prior art T-match dipole having the advantage of an input impedance which gets lower and more inductive as the taps are moved towards the centre and which may be matched by a feed containing some capacitance;

FIG. 7 shows a T-match applied to a folded dipole having a capacitive feed mechanism;

FIG. 8 shows an inverted T-matched folded dipole having the advantage that the antenna can also be fed separately as an unbalanced PIFA.

FIG. 9 shows a piece of flex circuit material configured for the manufacture of the embodiment of FIG. 8;

FIG. 10 shows the S₁₁ return loss measurements for the embodiment of FIGS. 8 and 9; and

FIG. 11 shows a variation of the embodiment of FIGS. 8 and 9 with coplanar capacitive high-band feeds.

### DETAILED DESCRIPTION

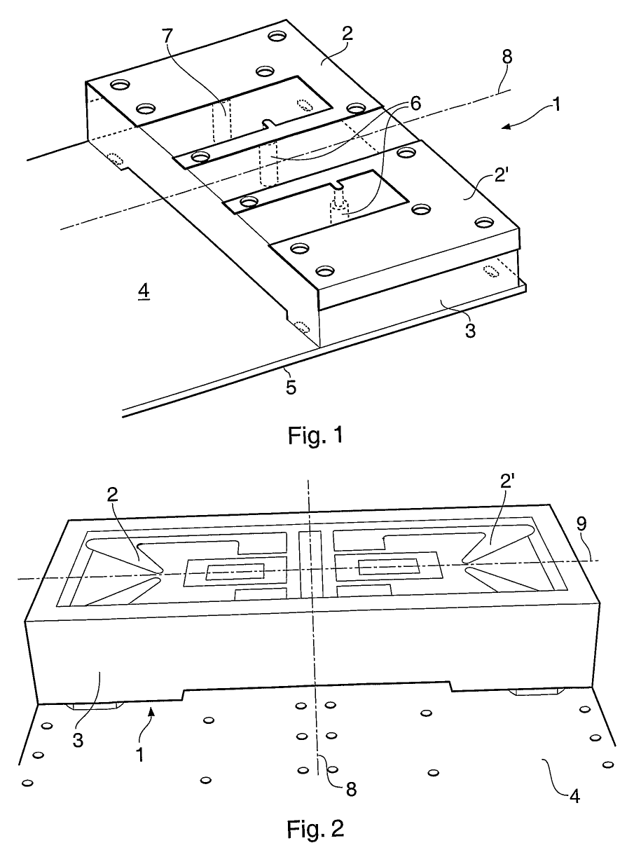

FIG. 1 shows an antenna module 1 comprising a pair of self-complementary PIFAs 2, 2′ mounted on a dielectric former element 3 which is turn is mounted on a PCB 4 having a conducive groundplane 5 on its underside. Each PIFA 2, 2′ has a shorting pin 6 and a feed 7. The PIFAs 2, 2′ are symmetrical about the long axis 8 of the PCB 4. Because each PIFA 2, 2′ excites an opposite current in the groundplane 5 to the other PIFA 2′, 2, the currents can be made to cancel each other out, leaving only very small residual currents on the groundplane. In this way, a pair of unbalanced antennas can be driven close to a groundplane.

FIG. 2 shows a variation of the embodiment of FIG. 1, with like parts being labelled as for FIG. 1. The embodiment of FIG. 2 has a pair of PIFAs 2, 2′ which have two-fold symmetry, i.e. are symmetric about both the long axis 8 and the short axis 9 of the PCB 4. By employing twofold symmetry (to both the PIFAs 2, 2′ and the pins 6, 7 (not shown in FIG. 2)), it is possible to achieve improved cancellation of groundplane currents.

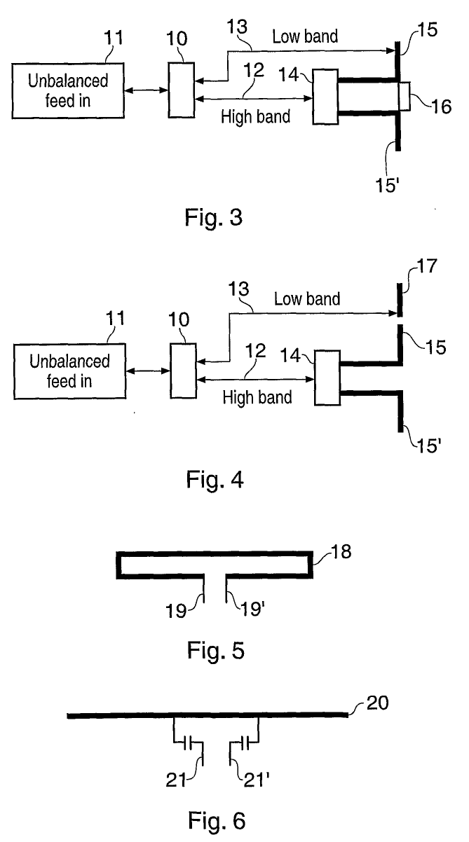

FIG. 3 shows an alternative antenna module comprising a diplexer 10 which serves to separate an unbalanced feed signal 11 into an unbalanced high-band signal 12 and an unbalanced low-band signal 13. The high-band signal 12 is fed to a balun 14 where it is converted into a balanced signal for feeding a balanced dipole pair of antenna elements 15, 15′. The antenna elements 15, 15′ are further, provided with a low-band shorting element 16, which may be an electronic or electromechanical switch or a low-pass filter or some form of resonant tank circuit adapted to pass only the low-band signal. Provision of the low-band shorting element 16 allows the antenna elements 15, 15′ to be fed by the unbalanced low-band signal 13 and together to act as a single unbalanced antenna in the low-band.

FIG. 4 shows a variation of the module of FIG. 3 in which a separate low-band unbalanced or monopole antenna element 17 is provided for the low-band signal. This low-band antenna element 17 may be located beneath the high band antenna elements 15, 15′ in the antenna module, or may alternatively be located elsewhere on a PCB on which the module is mounted.

FIG. 5 shows a normal, prior art folded dipole 18 with a pair, of galvanic feeds 19, 19′. The feeds 19, 19′ are balanced and have a 180° phase shift therebetween. The input impedance of this folded dipole 18 is fourfold higher than that of a simple dipole.

Another variation of the simple dipole is the T-match dipole 20, which is shown in FIG. 6. The T-match dipole 20 has a balanced pair of capacitive feeds 21, 21′. When the feeds 21, 21′ are connected at the far ends of the dipole element 20, the T-match dipole may be considered to be the same as the folded dipole 18 of FIG. 5. By moving the feeds 21, 21′ closer together; the Input impedance gets lower and more inductive. The T-match dipole is known from T. A. Milligan, “Modern antenna design”, 2^{nd} edition, IEEE Press, pp 248-249, 2005.

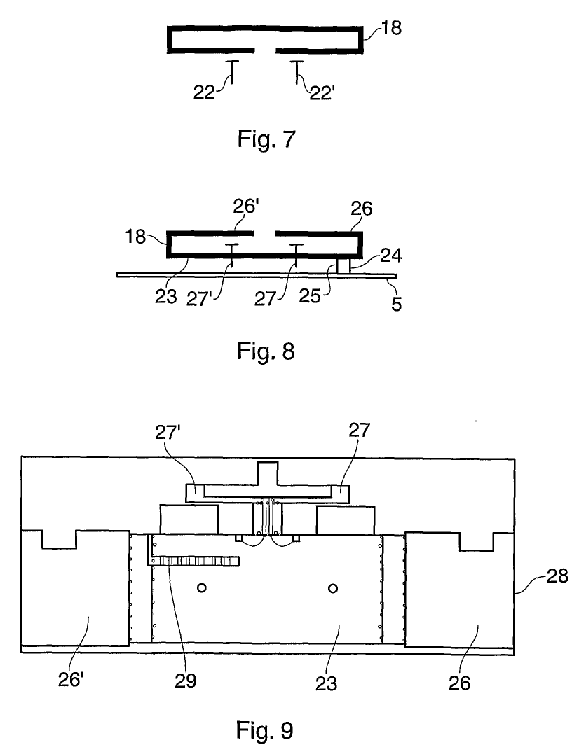

The present applicant has now made further developments, firstly by converting the T-match feeds or taps 21, 21′ of the FIG. 6 antenna into capacitive feeds rather than galvanic connections, and also by applying the feeds to a folded dipole. An interim stage is illustrated in FIG. 7, which shows a folded dipole 18 with a pair of capacitive feeds 22, 22′.

The next inventive step made by the present applicant, as shown in FIG. 8, is to invert the folded dipole 18 so that a lower section 23 thereof can be fed with an unbalanced low-band feed signal by way of a feed 24. The lower section 23 is also provided with a shorting pin 25 for connection to a conductive groundplane 5 which may be formed in a PCB. The upper section of the folded dipole 18, which comprises a pair of facing elements 26, 26′ folded back over the lower section 23 but spaced therefrom, serves as a high-band balanced antenna. A pair of balanced capacitive high-band feeds 27, 27′ are provided to drive the elements 26, 26′ as a high band dipole. The embodiment of FIG. 8 can be located close to a conductive grounded plane 5. The general configuration of the folded dipole 18 is planar, with the elements 26, 26′ being substantially parallel to the lower section 23. A slot (see FIG. 8) is cut into the lower section 23 close to the low band feed 24 and the shorting pin 26.

The structure of the FIG. 8 embodiment may be understood more clearly by considering the two frequency bands separately. In the low band, ignoring the presence of the high band feeds 27, 27′, the antenna acts as a conventional unbalanced slotted PIFA that has been bent up at each end to form a C shape. In the high band, the antenna acts as an inverted T-matched folded dipole, which is a balanced antenna. It has been found that this arrangement is relatively insensitive to integrated circuits and other electronic components mounted on the conductive plane 5 of the PCB 4, thereby allowing a radio-antenna module to be constructed. For cellular radio applications, the structure can be made relatively low in height, for example having a total height of 5.5 mm if no electronics bay is included underneath, and 7 mm if electronics are included.

FIG. 9 shows a net formed of flex circuit material 28 mounted on a plastics support carrier from which a balanced unbalanced antenna of the type shown in FIG. 8 may be fabricated. Like parts are labelled as for FIG. 8. There is also shown the slot 29 cut into the lower section 23 close to the low band feed and the shorting pin (not shown in FIG. 8). The left and right high-band elements 26, 26′ are bent upwards and back towards each other to form the high-band folded dipole, and the balanced high-band feed 27, 27′ is folded inside to drive the elements 26, 26′.

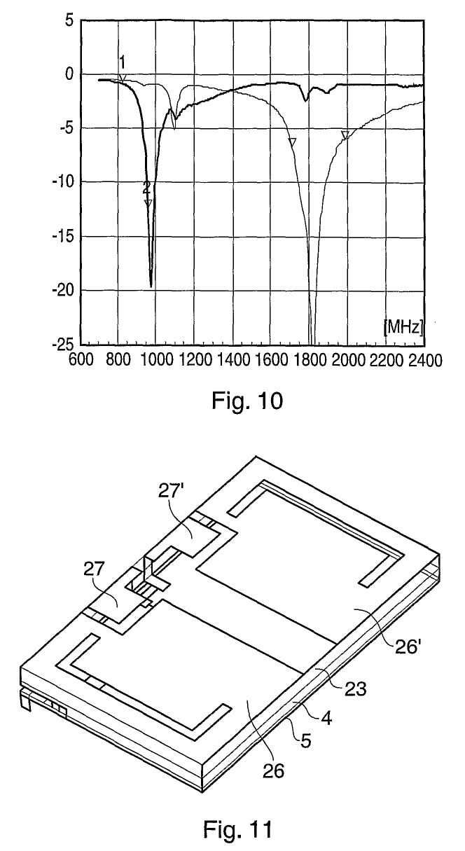

The S₁₁ return loss measurements for the antenna of FIG. 9 (configured as a cellular radio quadband antenna) are shown in FIG. 10. The four markers are set to frequencies 824 MHz, 960 MHz, 1710 MHz and 1990 MHz. Good bandwidth is evident from these results.

An additional pair of high band balanced antenna elements (not shown) may be provided on top of the elements 26, 26′ so as to achieve pentaband operation.

FIG. 11 shows a variation of the embodiments of FIGS. 8 and 9. Here, the high-band feeds 27, 27′ are coplanar, with the elements 26, 26′, but still operate as capacitive feeds.

It will be appreciated that in other embodiments, direct galvanic feed connections may be made for the high-band elements 26, 26′.

1. An antenna device comprising a pair of physically and electrically symmetrical radiating elements configured for cooperative operation as a balanced antenna, and a third radiating element configured for operation as an unbalanced antenna.

2. A device as claimed in claim 1, wherein the third radiating element is not co-located with the balanced antenna radiating elements.

3. A device as claimed in claim 1, wherein the balanced antenna radiating elements are provided as part of a support structure that encloses the unbalanced antenna radiating element.

4. A device as claimed in claim 1, wherein the unbalanced antenna radiating element is provided as part of a support structure that encloses the balanced antenna radiating elements.

5. A device as claimed in claim 3, wherein the support structure is made of a dielectric material.

6. A device as claimed in claim 4, wherein the support structure is designed to be attached to a PCB or PWB substrate.

7. A device as claimed claim 1, configured for operation in both first and second frequency bands, wherein the device acts as an unbalanced antenna in the first frequency band and as a balanced antenna in the second frequency band.

8. A device as claimed in claim 7, wherein the first frequency band is of lower frequency than the second frequency band.

9. A device as claimed in claim 7, wherein the first frequency band is of higher frequency than the second frequency band.

10. A device as claimed in claim 7, wherein the balanced antenna radiating elements are provided with a low-band shorting connection such that they together form the third, unbalanced radiating element in the first frequency band, while still acting separately as a balanced pair in the second frequency band.

11. A device as claimed in claim 7, further comprising a diplexer to separate an unbalanced feed signal into one or more signals in a first frequency band and one or more signals in a second frequency band, and a balun to convert the second band signals into a balanced feed signal for feeding to the balanced antenna radiating elements, wherein the first band signals are fed as an unbalanced signal to the unbalanced antenna radiating element.

12. A device as claimed in claim 7, further comprising a diplexer to separate a balanced feed signal into one or more signals in a first frequency band and one or more signals in a second frequency band, and a balun to convert the first band signals into an unbalanced feed signal for feeding to the unbalanced antenna radiating element, wherein the second band signals are fed as a balanced signal to the balanced antenna radiating elements.

13. A device as claimed in claim 1, wherein the balanced antenna radiating elements are symmetrical about a plane orthogonal to a principal direction of extension of the elements.

14. A device as claimed in claim 13, wherein the balanced antenna elements are additionally symmetrical about a plane containing the principal direction of extension of the elements.

15. A device as claimed in claim 1, wherein the balanced antenna radiating elements together comprise a device selected from the group consisting of: a dipole, a symmetrical pair of inverted-L antennas, a symmetrical pair of planar inverted-L antennas (PILAs), a symmetrical pair of inverted-F antennas, and a symmetrical pair of planar inverted-F antennas (PIFAs).

16. A device as claimed in claim 1, wherein the unbalanced antenna radiating element is configured as a device selected from the group consisting of: a monopole, an inverted-L antenna and PILA.

17. A device as claimed in claim 1, further comprising a push-pull balanced feed between the balanced antenna radiating elements, and means for adjusting a phase shift between the feeds to each of the balanced antenna radiating elements so as to change a direction of signal radiation or reception.

18. A pair of antenna devices as claimed in claim 1 mounted orthogonally to each other.

19. An antenna device comprising: i) first and second antenna elements; ii) a diplexer to separate an unbalanced feed signal into an unbalanced first frequency band feed signal and an unbalanced second frequency band feed signal; iii) a balun to convert the unbalanced second frequency band feed signal into a balanced second frequency band feed signal for feeding the first and second antenna elements together as a balanced pail; and iv) a first frequency band shorting element connecting the first and second antenna elements such that the first and second antenna elements can be driven together as an unbalanced antenna by the unbalanced first frequency band feed signal.

20. A device as claimed in claim 19, wherein the first frequency band shorting element comprises a device selected from the group consisting of: a low or high pass filter, a resonant tank circuit, an electronic, and an electromechanical switch.

21. An antenna device comprising: i) first and second antenna elements; ii) a diplexer to separate a balanced feed signal into: a) a balanced second frequency band feed signal for feeding the first and second antenna elements together as a balanced pair, and b) a balanced first frequency band feed signal; iii) a balun to convert the balanced first frequency band feed signal into an unbalanced first frequency band feed signal, and iv) a first frequency band shorting element connecting the first and second antenna elements such that the first and second antenna elements can be driven together as an unbalanced antenna by the unbalanced first frequency band feed signal.

22. A device as claimed in claim 21, wherein the third unbalanced antenna element is located adjacent to the first and second antenna elements.

23. A device as claimed in claim 21, wherein the third unbalanced antenna element is located remote from the first and second antenna elements.

24. A device as claimed in claim 19, wherein said first and second antenna elements are symmetric about a single plane of symmetry.

25. A device as claimed in claim 19, wherein said first and second antenna elements are symmetric about two orthogonal planes of symmetry.

26. An antenna device comprising a first generally planar conductive element having first and second opposed ends, and second and third generally planar conductive elements depending respectively from said first and second opposed ends and folded back towards each other over the first element and spaced therefrom, wherein the first element is provided with a feed for an unbalanced first frequency band signal and wherein the second and third elements are respectively provided with a feed for a balanced second frequency band signal.

27. A device as claimed in claim 26, wherein the second and third elements are coplanar with each other and parallel to the first element.

28. A device as claimed in claim 26, wherein the feed for the balanced second frequency band signal comprises a pair of capacitive feeds, one for each of the second and third elements.

29. A device as claimed in claim 28, wherein the capacitive feeds are not coplanar with the second and third elements.

30. A device as claimed in claim 28, wherein the capacitive feeds are coplanar with the second and third elements.

31. A device as claimed in claim 26, wherein the feed for the balanced second frequency band signal comprises a pail of galvanic feeds, one for each of the second and third elements.

32. A device as claimed in claim 19, at least partially contained within a dielectric housing so as to form a module adapted for mounting on a printed circuit board or similar substrate having a conductive groundplane.

33. A device as claimed in claim 26, mounted on a printed circuit board or similar substrate having a conductive groundplane.

34. A device as claimed in claim 26, further comprising an additional pair of balanced radiating antenna elements.

35. (canceled)

36. A device as claimed in claim 4, wherein the support structure is a housing structure.

37. A device as claimed in claim 6, wherein the support structure is attached by clipping.

38. A device as claimed in claim 7, wherein both the first and second frequency bands are non-over lapping frequency bands.
